(19) United States
(12) Patent Application Publication
(10) Pub. No.: US 2016/0299000 A1
(43) Pub. Date: Oct. 13, 2016

(54) Dynamic System to Capture and Assess Calories and Nutrients Inputs to Provide Dietary Recommendations

(71) Applicant: Aegle Health LLC, Shawnee, KS (US)

(72) Inventors: Chieko Arai, Shawnee, KS (US); Yulin Li, Shawnee, KS (US); Milton S. Arai Li, Shawnee, KS (US); Gordon S. Arai Li, Shawnee, KS (US)

(73) Assignee: Aegle Health LLC, Shawnee, KS (US)

(21) Appl. No.: 15/102,660

(22) PCT Filed: Jun. 4, 2015
(86) PCT No.: PCT/US15/34284

§ 371 Date: Jun. 8, 2016

Related U.S. Application Data
(60) Provisional application No. 62/007,418, filed on Jun. 4, 2014.

(51) Int. Cl. G01G 19/414; G01G 19/415; G09B 19/00; G01G 23/37

(52) U.S. Cl. CPC G01G 19/4146; G01G 23/3735; G01G 19/415; G09B 19/0092

(57) ABSTRACT

The present invention provides a method and apparatus to dynamically capture and assess calories and nutrients inputs from foods and beverages to perform calories and nutrients gap analysis based on personal goals and demographics, and to provide dietary recommendations to help people live a healthy life. The dynamic Cloud-based system efficiently and interactively captures calories and nutrients inputs, and enables users access to the data anywhere they have internet access. Furthermore, the system also allows users to monitor their gap and progress made according to personal dietary goals, and provides dietary recommendations. An optimization utility takes into account demographics, health and dietary history, goals and cuisine preferences.

### CROSS-REFERENCE TO RELATED APPLICATION

This application claims the benefit of co-pending provisional application Ser. No. 62/007,418, filed on Jun. 4, 2014, entitled A DYNAMIC SYSTEM THAT CAPTURES AND ASSESSES CALORIES AND NUTRIENTS INPUTS SO TO PROVIDE DIETARY RECOMMENDATIONS.

### FIELD

The present invention relates generally to a method and apparatus to dynamically capture and assess calories and nutrients inputs from foods and beverages, and, more particularly, to a method and apparatus to dynamically capture and assess calories and nutrients inputs from foods and beverages to perform calories and nutrients gap analysis based on personal goals and demographics, and to provide dietary recommendations to help people live a healthy life.

### BACKGROUND

It has been a conventional belief that effectively managing calories and nutrients consumptions by making informed food choices combined with physical activities can help people maintain a healthy weight level, significantly reduce their risk of chronic disease, and promote a healthy life.

Dietary Guidelines for Americans, 2010, is a comprehensive dietary resource provided by the U.S. Department of Agriculture (USDA) and Health and Human Services (HHS). The purpose of the 2010 dietary guidelines is to educate, inform and promote healthy life through managing nutrients and calories consumptions. Despite people's general understanding and vast available resources, the reality, however, is that most people living a busy life do not have efficient means to monitor and manage calories and nutrients contents in the foods and beverages they consume daily. Hence, they cannot take proactive actions to adjust their lifestyle and live a healthy life.

Currently, there are various calories counters that calculate calories consumed of a meal mainly based on the following variables: food type, how foods are prepared and net amount of foods and beverages consumed accounting for leftovers. Calories are, however, only one part of the puzzle to a healthy life since people need to have a better understanding of the nutrients components of foods and beverages they consume, e.g., carbohydrates and proteins. Furthermore, nutrition counters are more focused on commercial use by chefs in the kitchen as they are bulky, stationary, and aesthetically unappealing.

There are various web sites that promote healthy diets by educating and informing users how to make right food choices and set up personal goals according to their age, gender, stage in life and medical conditions. However, these web sites, to a large extent, rely on voluntary inputs of users to provide daily dietary data to monitor their progress towards their health goals. The voluntary input process is time consuming, tedious and less reliable as people may forget and fail to input data due to their busy life.

Thus, an integrated system that captures calories and nutrients and makes dietary recommendations based on analytic results is desired.

### SUMMARY

The present invention provides a method and apparatus to dynamically capture and assess calories and nutrients inputs from foods and beverages to perform calories and nutrients gap analysis based on personal goals and demographics, and to provide dietary recommendations to help people live a healthy life. The dynamic Cloud-based system efficiently and interactively captures calories and nutrients inputs, and enables users access to the data anywhere they have internet access. Furthermore, the system also allows users to monitor their gap and progress made according to personal dietary goals, and provides dietary recommendations. An optimization utility takes into account demographics, health and dietary history, goals and cuisine preferences.

A digital device with various alternative embodiments that makes it convenient to capture calories and nutrients information of foods and beverages users consume daily and seamlessly communicates with other portable devices and computers. The data is then automatically synced with the Cloud account to allow further monitoring and analysis.

### BRIEF DESCRIPTION OF DRAWINGS

FIG. 1 is a plan view of a digital mat of the present invention.

FIG. 2 is a bottom view of the digital mat of FIG. 1.

FIG. 3 is a top view of the digital mat of FIG. 1.

FIG. 4 is a right side view of the digital mat of FIG. 1.

FIG. 5 is a left side view of the digital mat of FIG. 1.

FIG. 6 is a perspective view of the digital mat of FIG. 1.

FIG. 7 is a function block diagram of the components of the digital mat of FIG. 1.

FIG. 8 is a plan view of a digital kitchen scale of the present invention.

FIG. 9 is a top view of the digital kitchen scale of FIG. 8.

FIG. 10 is a right side view of the digital kitchen scale of FIG. 8.

FIG. 11 is a perspective view of the digital kitchen scale of FIG. 8.

FIG. 12 is a functional block diagram of the components of the digital kitchen scale of FIG. 8.

FIG. 13 is a flow chart of the dynamic system from an input device to recommendation generation.

FIG. 14 is an illustration of the digital kitchen scale weighing a food item.

FIG. 15 is an illustration of a bowl placed on the digital kitchen scale.

FIG. 16 is an illustration of the digital kitchen scale weighing a food item in the bowl.

FIG. 17 is an illustration of the digital mat with a dinner plate, glass and utensils.

FIG. 18 is an illustration of the digital mat with a dinner plate, glass utensils, and a food item.

FIG. 19 is an illustration of the digital mat with a dinner plate, glass utensils, and two food items.

FIG. 20 is an illustration of the digital mat with a dinner plate, glass utensils, and a leftover food item.

FIG. 21 is a perspective illustration of a digital tray of the present invention.

FIG. 22 is a top illustration of a digital cup holder of the present invention.

FIG. 23 is a front elevational illustration of the digital cup holder of FIG. 22 and a cup.

### DETAILED DESCRIPTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. The drawings constitute a part of this specification and include exemplary embodiments of the present invention and illustrate various objects and features thereof.

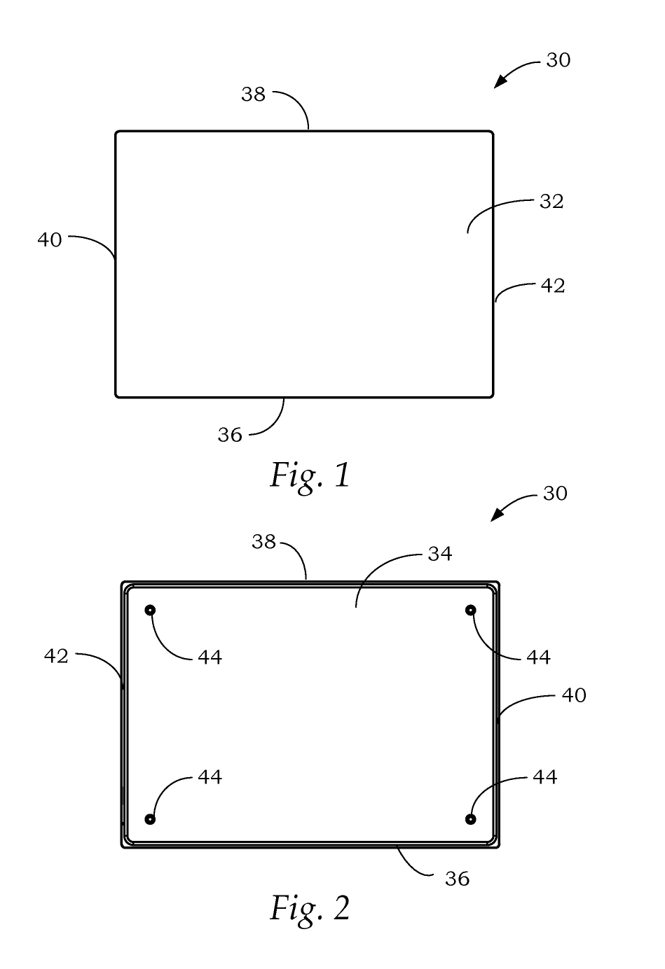

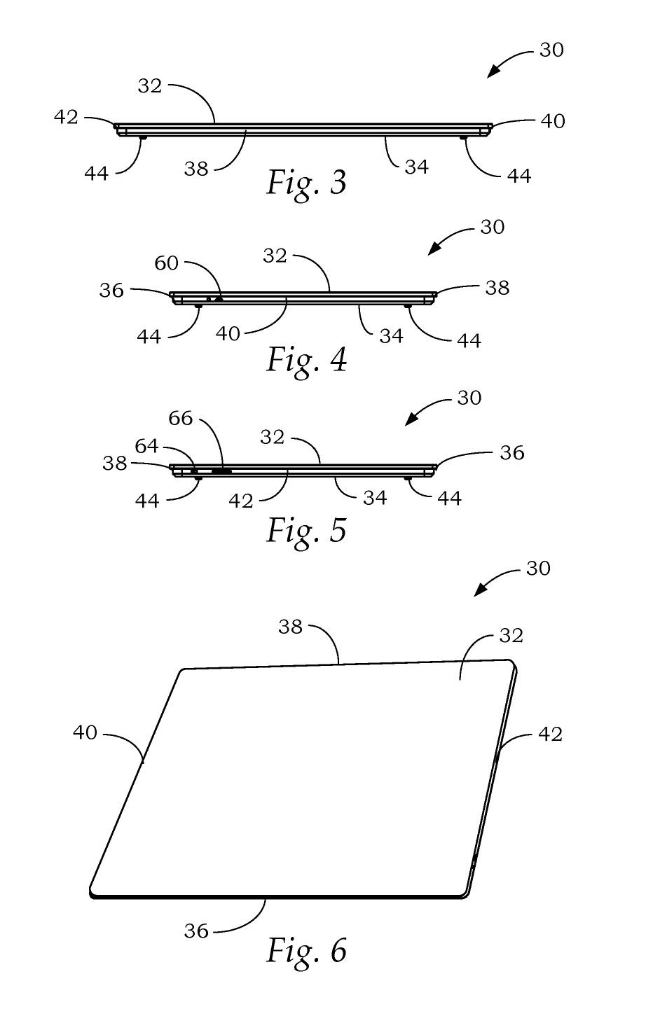

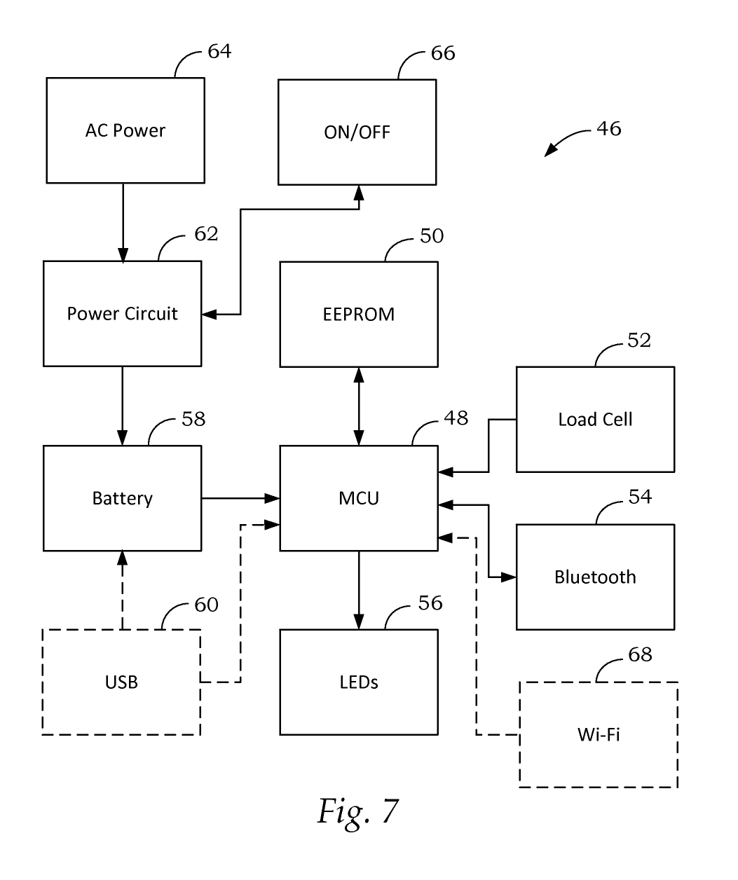

Referring initially to FIGS. 1-7, a digital mat of the present invention is generally indicated by reference numeral 30. The digital mat 30 includes a top surface 32, a bottom 34, and front 36, rear 38, left 40 and right 42 sides. The digital mat 30 may include one or more rubber feet 44 on the bottom surface 34. The top surface 32 may be glass, acrylic, or other material that is durable and cleanable, for example. The digital mat 30 includes a control system 46 with a microprocessor 48 coupled to an EEPROM 50, a load cell 52, a Bluetooth® interface 54, LEDs 56 and battery 58. The microprocessor 48 may be coupled to a USB port 60 for interfacing with a computer or other smart device, and for receiving power, for example. The battery 58 may receive power via the USB port 60, or through a power circuit 62 coupled to an external power source 64 such as AC power, and controlled by an ON/OFF switch 66. The LEDs 56 allow the color of the digital mat 30 to be changed as desired by the user.

The load cell 52 is a transducer that is used to create an electrical signal whose magnitude is directly proportional to the force being measured. The various types of load cells include hydraulic load cells, pneumatic load cells and strain gauge load cells. Preferably, load cell 52 is a strain gauge mechanically coupled to the top surface 32 of the digital mat 30 and electrically coupled to the microprocessor 48. The load cell 52 sends an electronic signal to the microprocessor 48, which is proportional to the force or weight of an item placed on the top surface 32 of the digital mat 30. The microprocessor 48 receives the signal from the load cell 52 and calculates the weight of the item placed on the top surface 32 of the digital mat 30.

The digital mat 30 may wirelessly communicate with other devices via the Bluetooth® interface 54. Optionally, the digital mat 30 may include a Wi-Fi interface 68 for wirelessly connecting to the internet or other Wi-Fi enabled devices. Bluetooth® is the preferred wireless interface because of the lower power use of the Bluetooth® technology versus Wi-Fi.

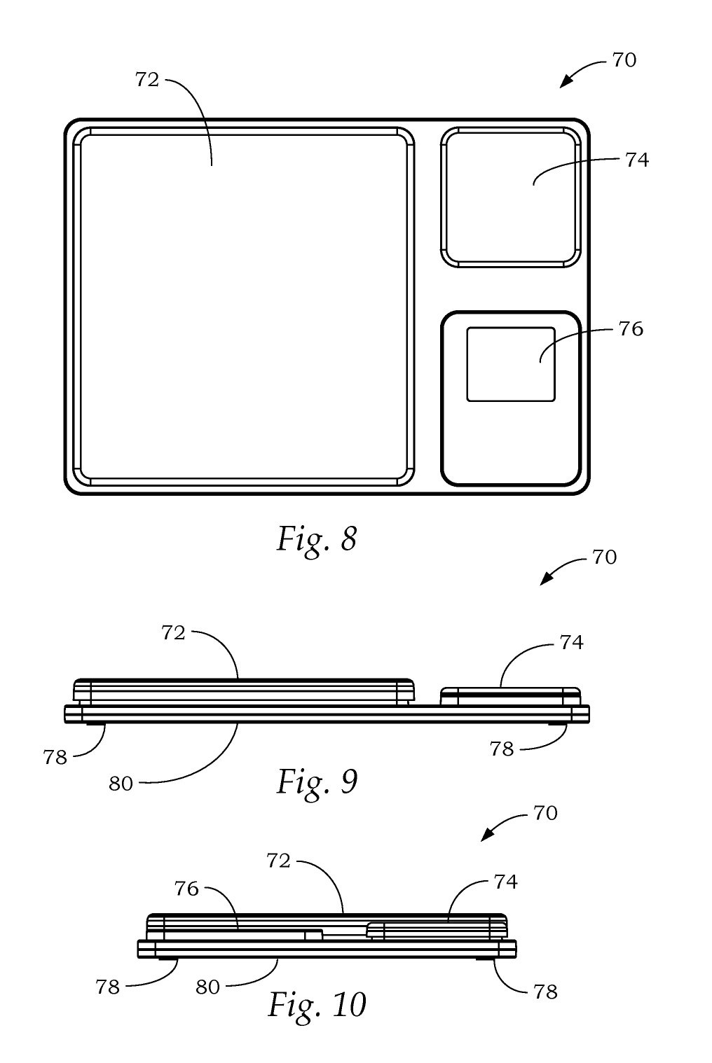

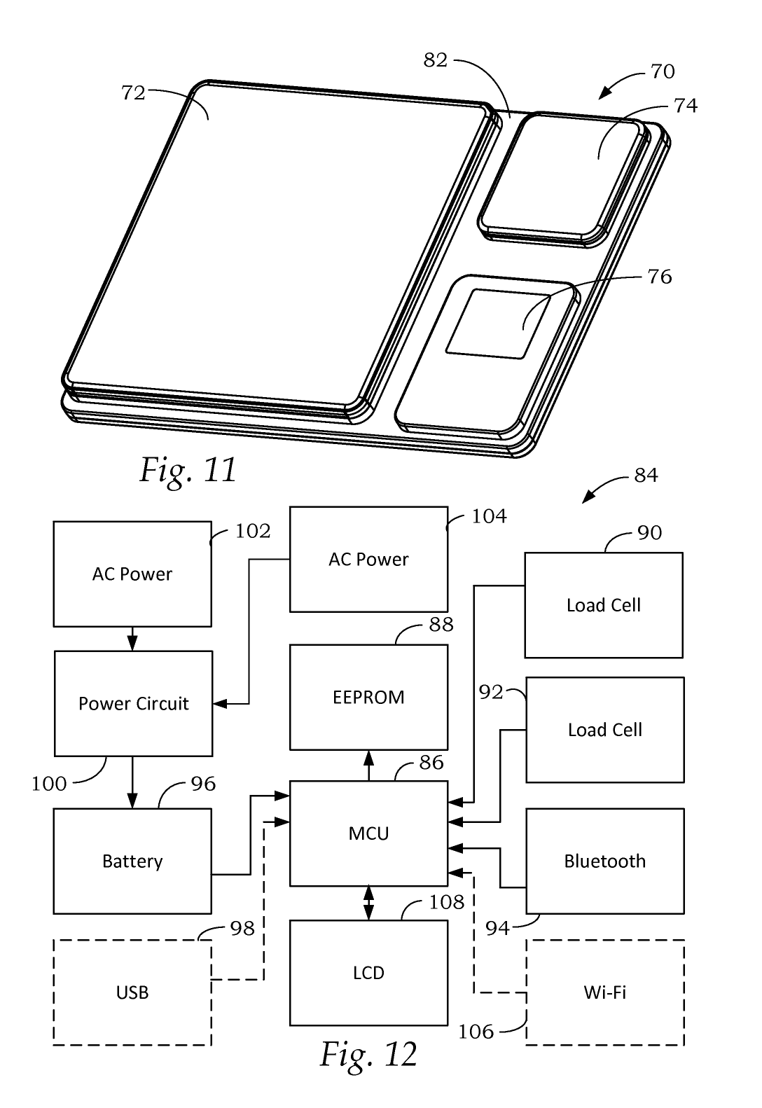

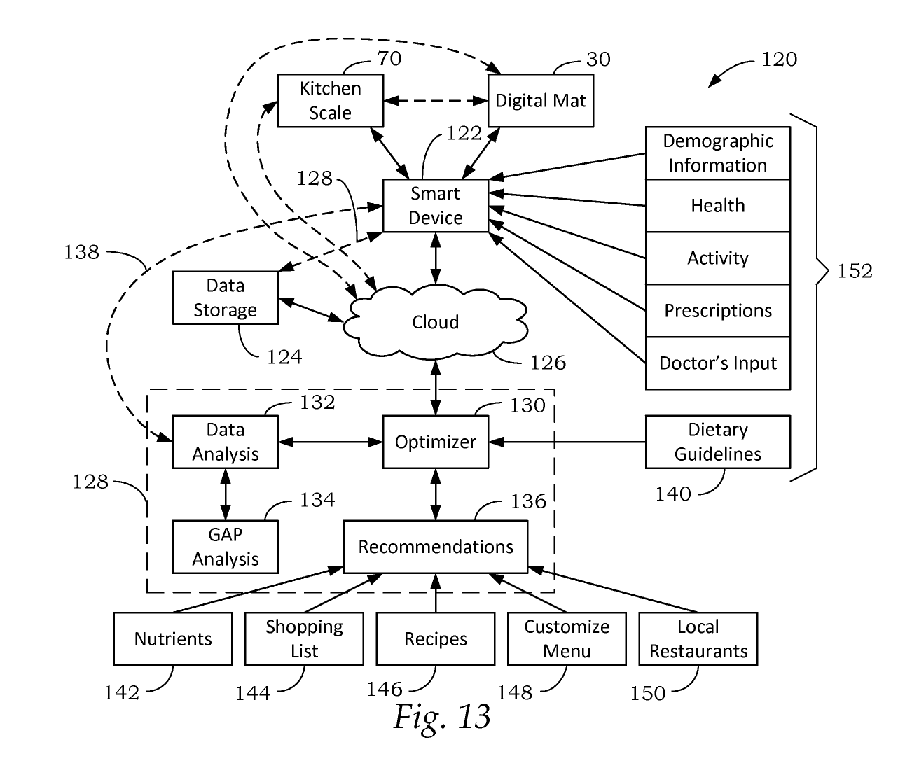

Referring to FIGS. 8-12, a kitchen scale is generally indicated by reference numeral 70. Kitchen scale 70 includes a large scale pad 72, a small scale pad 74, and a display 76. The kitchen scale 70 may include rubber feet 78 mounted to a bottom surface 80. The large scale pad 72, small scale pad 74, display 76 and top surface 82 may be glass, acrylic, or other material that is durable and cleanable, for example. The large scale pad 72 may be used to measure the weight of bulk items or larger quantities of an item. The small scale pad 74 may be used to precisely measure small portion ingredients, e.g. salt, garlic, spices, etc. The large scale pad 72 may have a precision of 0.1 gm while the small scale pad 74 may have a precision of 0.01 gm, for example.

The kitchen scale 70 includes a control system 84 with a microprocessor 86 coupled to an EEPROM 88, a first load cell 90, a second load cell 92, a Bluetooth® interface 94, and battery 96. The microprocessor 86 may be coupled to a USB port 98 for interfacing with a computer or other smart device, and for receiving power, for example. The battery 96 may receive power via the USB port 98, or through a power circuit 100 coupled to an external power source 102 such as AC power, and controlled by an ON/OFF switch 104.

The first load cell 90 and second load cell 92 are transducers, preferably strain gauges. The first load cell 90 is mechanically coupled to the large scale pad 72 of the kitchen scale 70 and electrically coupled to the microprocessor 86. The first load cell 90 sends an electronic signal to the microprocessor 86, which is proportional to the force or weight of an item placed on the large scale pad 72 of the kitchen scale 70. The microprocessor 86 receives the signal from the first load cell 90 and calculates the weight of the item placed on the large scale pad 72 of the kitchen scale 70. The second load cell 92 is mechanically coupled to the small scale pad 74 of the kitchen scale 70 and electrically coupled to the microprocessor 86. The second load cell 92 sends an electronic signal to the microprocessor 86, which is proportional to the force or weight of an item placed on the small scale pad 74 of the kitchen scale 70. The microprocessor 86 receives the signal from the second load cell 92 and calculates the weight of the item placed on the small scale pad 74 of the kitchen scale 70.

The kitchen scale 70 may wirelessly communicate with other devices via the Bluetooth® interface 94. Optionally, the kitchen scale 70 may include a Wi-Fi interface 106 for wirelessly connecting to the internet or other Wi-Fi enabled devices. Bluetooth® is the preferred wireless interface because of the lower power use of the Bluetooth technology versus Wi-Fi. Additionally, the kitchen scale 70 may include an LCD touch screen display 108 coupled to the microprocessor 86 for receiving user input and displaying information.

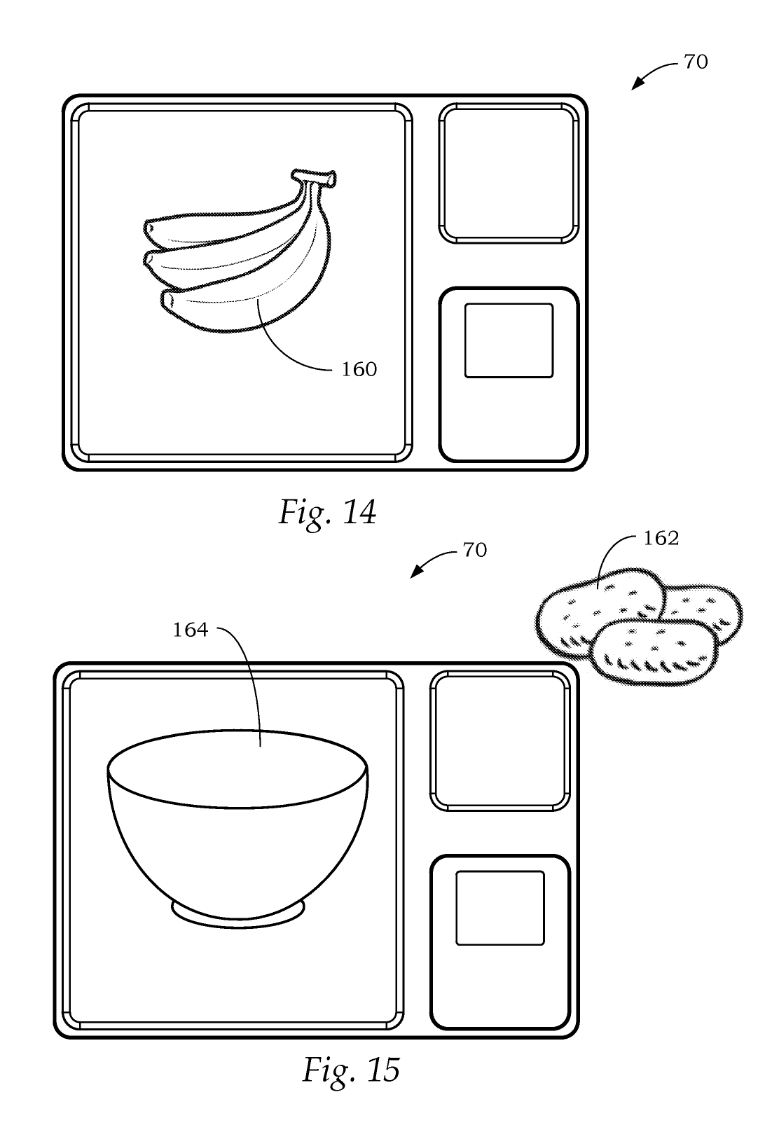

Referring to FIG. 13, a flow chart illustrating the processing and method of the present invention is generally indicated by reference numeral 120. The digital mat 30 and kitchen scale 70 may be coupled to a smart device 122, such as a smart phone, tablet, personal computer, laptop computer, or other device, for example. The smart device 122 may receive weight data or item identifying data from the digital mat 30 and kitchen scale 70. Data received by the smart device 122 is stored in a data storage 124 through the internet 126, or locally 128 in the internal storage of the smart device 122. As illustrated, the cloud 126 may be an internet server system that may be accessible via Wi-Fi, ethernet or through a cellular network, for example.

Data analysis tools 128 include an optimizer 130, data analysis 132, GAP analysis 134, and recommendations 136. Data analysis tools 128 may be hosted in the cloud 126 or locally on the smart device 122. Data is received from the smart device 122 directly 138 or through the cloud 126 for analysis. Based on the input data received, a GAP analysis 134 is performed to assess the differences between the performance and the goals set by the user. The optimizer 130 compares the analysis to the dietary guidelines 140 available from the Dietary Guidelines for Americans by the USDA and HHS, for example. Based on these data points, recommendations 136 are determined to help the user attain his/her goals. Recommendations 136 may receive inputs from nutrient lists 142 for a particular packaged food, ingredient, or food type. Shopping lists 144 may be developed to match recommended dietary guidelines 140, or from recommended recipes 146. Using the recommended nutrients, shopping list and recipes, a customized menu 148 may be developed for the user. Local restaurants 150 meeting the dietary recommendations may be suggested, or menu items from the local restaurants 150 may be input to the recommendations 136 for tracking and analysis. Overall, the process 120 is used to capture, track, analyze and recommend dietary guidance to achieve nutritional and physical goals for desired outcomes for an individual based on specific health related information, such as age, gender, stage in life, health condition, activity level, etc. 152.

The dynamic system is intended to provide a convenient and effective means to allow users to capture and assess calories and nutrients inputs so to make dietary decisions based on the recommendations provided by the system. A user can start with setting up Cloud-based individual and multi-user accounts by identifying their general information and entering more specific health related information, such as age, gender, stage in life, health condition, activity level, etc. Once individual and multiuser accounts are set up in the Cloud, a user can start using a digital mat to automatically capture daily inputs and monitor dietary patterns over time. The interactive process communicates and synchronizes seamlessly and automatically among the digital mat, existing devices, e.g., smart phones and tablets, and the Cloud. The system automatically performs data analysis and gap analysis, and identifies insufficient nutrition and recommends dietary actions. A user can access the complete dietary history, gap analysis, and actionable recommendations anywhere internet is available and through any chosen device. This digital dietician enables timely dietary monitoring and management so a user can make a dietary decision before each meal. Over a period of time, a user following the dietary recommendations can take proactive actions such as preparing recommended healthy foods via provided recipes at home or dining at select restaurants. A user can also order directly from customized menus that correspond to dietary needs and preferences.

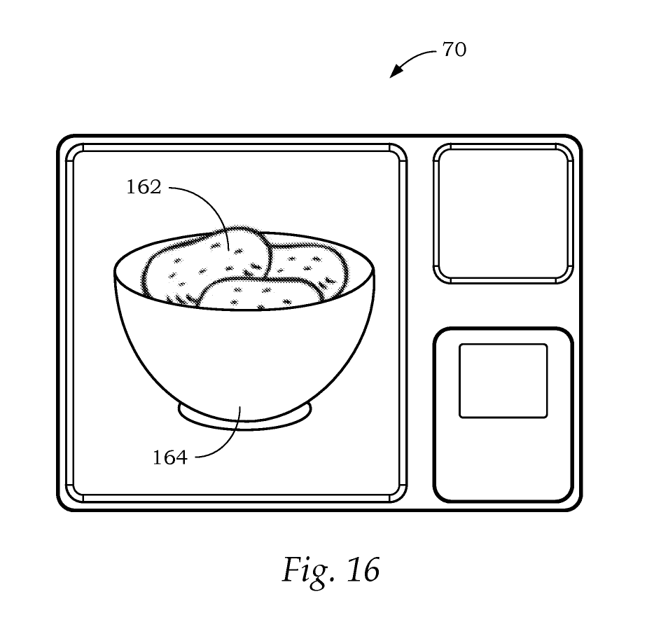

Referring to FIGS. 14-16, a kitchen scale 70 is illustrated for use when preparing a meal. For example, a bunch of bananas 160 may be placed on the large scale 72 to weigh the bananas 160. The user may select “bananas” from a food selection menu on the display 76, or on a smart device 122 coupled to the kitchen scale 70. Bananas are approximately 4200 calories per kilogram. A 120 gm (quarter pound) banana may have well known nutritional values and 105 calories. The three bananas illustrated in FIG. 14 may weigh 360 gm, with 315 calories. The kitchen scale 70 may transmit the information regarding the bananas 160 to the smart device 122. If the bananas 160 are being served for breakfast, for example, “bananas” may be added to a custom menu to be selected from a smart device 122 at meal time. If a food item, such as potatoes 162, needs to be weighed in a bowl 164, the bowl 164 may be placed on the large scale 72 and zeroed before adding the potatoes 162. Then when the potatoes 162 are added to the bowl 164, only the weight of the potatoes 162 is transmitted to the smart device 122. In this way, a complete meal may be created and analyzed before selection by the individuals at the dinner table.

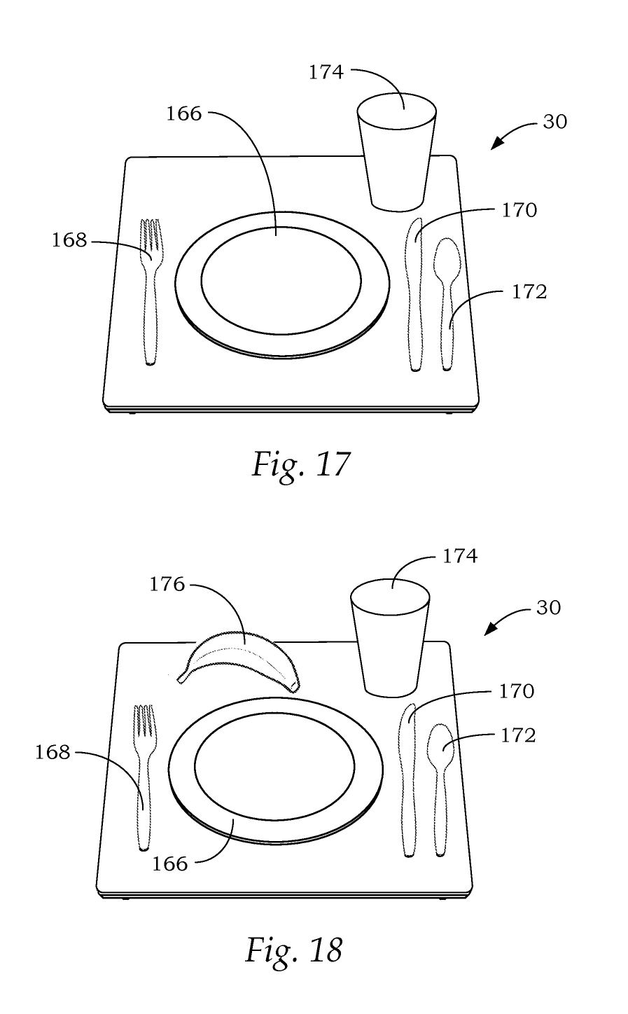

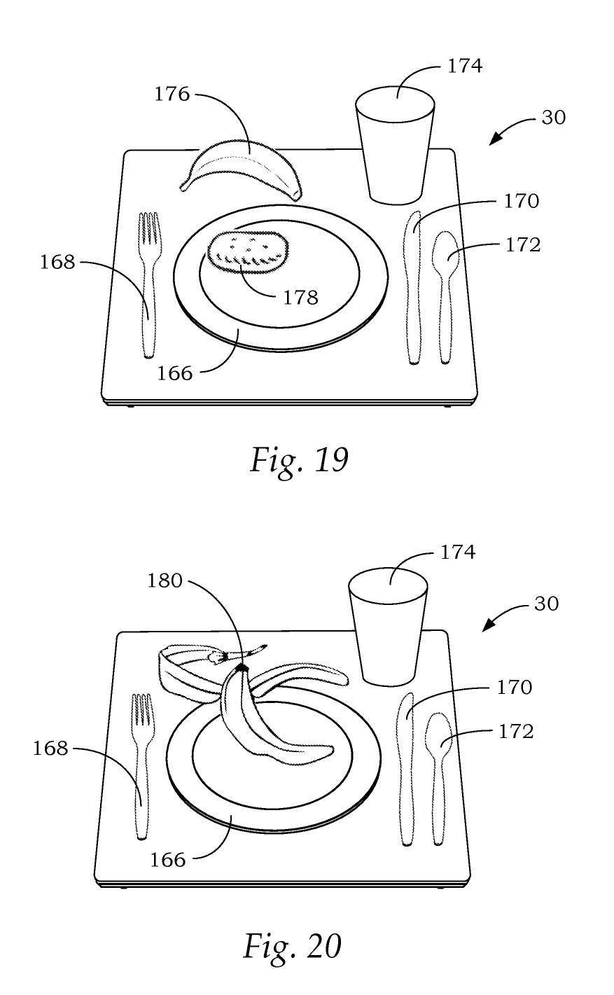

Referring to FIGS. 17-20, the smart mat 30 is illustrated with a plate 166, fork 168, knife 170, spoon 172 and cup 174. With the plate 166 and cup 174 empty, the weight of these may be zeroed by the smart device 122. As food items such as a banana 176 and potato 178 are added to the digital mat 30, the user selects the food item from the menu for the particular meal. For example, the user may first select “banana” from the menu, and then place the banana 176 on the smart mat 30. The digital mat 30 may then determine the weight of the item placed on the digital mat 30, and transmit the weight to the smart device 122. The smart device 122 may then calculate the calories of the banana 176 based on the weight, and also retrieve the nutritional information for the banana 176. Next, the user may zero the smart device 122, and put a potato 178 on the plate 166. The weight of the potato 178 is transmitted to the smart device 122, which then calculates the calories for the potato 178 based on the weight and retrieves the nutritional information for the potato 178. The way that the potato 178, such as baked, deep fried, boiled, or microwaved, as well as any condiments added to the potato 178, such as butter, sour cream, salt, pepper, etc., may be selected from a menu on the smart device 122. In this manner, the complete meal may be recorded for each individual based on their own digital mat 30. Likewise, if a drink such as milk or water is added to the cup 174, the weight and nutritional values are determined and stored in the smart device 122 or in the cloud 126.

When the meal is finished, there may be leftovers, or amounts not consumed. For example, typically the banana peel 180 is not consumed with the banana. The smart mat 30 may be zeroed using the smart device 122. The banana peel 180 may be removed from the plate 166 and “banana” selected from the meal menu on the smart device 122. The weight of the banana peel 180 is then subtracted from the weight of the banana 176 previously recorded so that an accurate accounting of the nutrients and calories consumed may be recorded. Likewise, this may be repeated for each leftover food.

In operation the digital mat 30 with several alternative embodiments, captures calories and nutrients inputs data through its built-in digital scale, and data interface to include foods variables, e.g. name of food, how foods are prepared. The data are then automatically sent to and synced with a user's individual account in a central data depository in a managed Cloud 126 through wired or wirelessly connection, e.g. Bluetooth®, with smart devices 122, e.g., smart phones or tablets or PC. The same process used by an individual user can be applied to a multiple users account with data synced with the multiple users account in the Cloud 126.

Based on the captured data inputs, e.g., name of food, how foods are prepared and weight of foods consumed, the Cloud 126 performs data analysis that compares the amount of calories and nutrients consumed with the targeted amount of calories and nutrients, so a GAP analysis can be generated and easily viewed and monitored. One of the major advantages of the system is a linkage with updated calories and nutrients data provided by the Dietary Guidelines for Americans by the USDA and HHS 140 so a user can view not only calories consumed but also detailed nutrients, e.g., proteins and carbohydrates, of each food and meal.

The data may be combined with idiosyncratic data inputs of the user 152, i.e., age, gender, stage in life (pregnancy), health condition (prescription and doctors' recommendations), activity level and location in order to perform an optimization analysis and to generate actionable dietary recommendations 136. The forms of recommendations 136 may be 1) nutrients and calories; 2) specific ingredients to buy and consume; 3) downloadable digital recipes that meet individual needs; 4) a customized dining menu for catering and delivery; 5) detailed menu items in local restaurants that meet recommended nutrients and calories goals in various cuisines. The interactive process can be dynamically performed on daily, weekly, monthly or even longer time frame to provide a dietary history that can be monitored and actioned upon so to promote healthy living.

The digital mat 30 allows a user to input foods and beverages information before a meal, e.g., name of foods, how foods are prepared. A built-in digital scale 52 weighs them before and after meals to calculate the net amount consumed. A user has several input options: 1) manually enter name of foods and beverages on touch screen, push buttons or through voice recognition; 2) manually enter Nutrition Facts provided on a majority of food packages or employ picture recognition for the same input purpose. The main components of the digital mat 30 include a micro-processor 48, memory, and communication devices, e.g., wireless adaptor 68 and Bluetooth® 54. The digital mat 30 is water-proof so it can be easily cleaned. A user may use the digital mat 30 on a dining table along with plates, bowls and cups without any requirement of replacement or change of tableware.

A system composed of 1) digital devices 30 and 70 that can efficiently capture and assess calories and nutrients inputs and 2) Cloud-based data storage 124 and calculation engines 128 that perform detailed calories and nutrients analyses and dynamically interact with users by providing actionable dietary recommendations is provided. The system enables users to use the digital devices to conveniently capture calories and nutrients inputs while they prepare foods or/and they have meals. Dietary data are automatically sent to and synced with a central data depository in the Cloud 126 using smart devices 122, such as smart phones or tablets. Users can then monitor their dietary pattern over time or even live at the dining table, and take actions according to their health goals and recommendations that fit their own individual characteristics, e.g., age, gender, stage in life, health condition, and activity level. The system promotes a healthy life style by utilizing an optimized dietary plan and operates as a private digital dietician that constantly monitors and manages dietary patterns, and interacts with users to help achieve lifetime health goals.

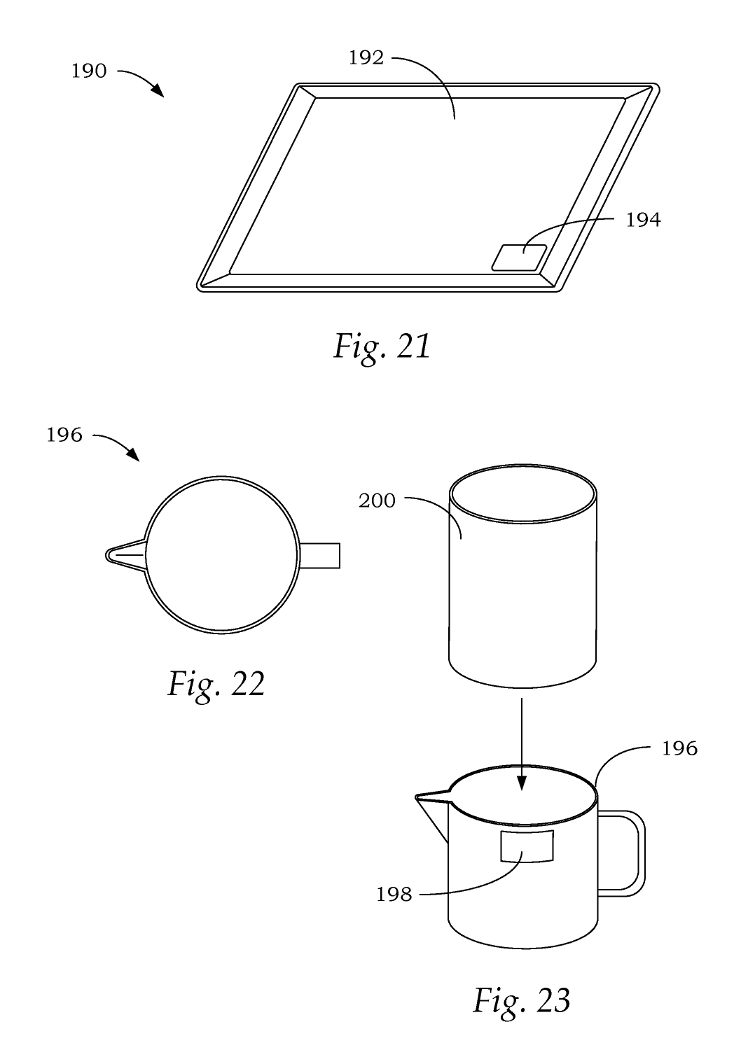

It should be understood that alternative embodiments of the digital devices that capture calories and nutrients inputs may be provided. Referring to FIGS. 21-23, a digital application of a traditional service plate or tray with all the same functions as those in a digital mat 30 allows a user to serve conventional plates or bowls on the top of it. The serving tray 190 may be configured with multiple load cells 192 coupled to separate pads, which can be configured and temporarily labeled for a particular food item, and include a display 194 to provide information to the user. The serving tray 190 may be coupled to individual digital mats 30 and automatically transfer information to the digital map 30 when the weight of a food removed from the serving tray 190 matches the weight of the food added to a digital mat 30. A digital device that captures calories and nutrients inputs of beverages may also be used. A digital cup holder 196 with a display 198 may include all the same functions as those in a digital mat 30 allows a user to hold and be served with a conventional cup 200 inside the cup holder. The amount and type of beverages consumed may be captured by the device that can be directly synced with the central data depository. This information may be monitored by a master smart device such as a digital pad, for example. Precise measurement scales may be used in conjunction with the digital mat 30 at the table for precisely weighing salt or other spices added to the user's food at the dinner table. A speaker system may be incorporated into the digital mat 30 or kitchen scale 70 to orally output the name of the food item place on the digital mat 30 or kitchen scale 70, or other sound signal.

The operation of a digital mat 30 only requires a user to provide specific inputs, e.g., name of foods and beverages, how foods are prepared, while weight and amount consumed is automatically calculated. A user also has several input options: 1) manually enter name of foods and beverages on touch screen, push buttons, through voice recognition via a microphone, or picture recognition via a camera; 2) manually enter Nutrition Facts provided on a majority of food packages or employ picture recognition for the same input purpose. Cooking at home, a user who prepares meal for multiple people can choose to enter the common data only once either using a digital kitchen scale 70 or using a smart device 122 (a smart phone). On a dining table, a user needs only to weigh each dish twice—once before and once after each meal—so to capture the net weight consumed—a process that automatically considers leftovers. A user can also include other variables into the system that affect the calories and nutrients count, for instance, consuming noodle with soup or without soup—as soup tends to contain higher salt content. The device recognizes how the food is prepared by the name. Before, during or after each meal, a user can view calories and nutrients information of the meal to be consumed, review current dietary history over a chosen period time, and monitor progress made toward health goals. In combination with other health actions, such as physical activities, a user has a better chance to achieve his/her health goals to live a healthy life.

It is to be understood that while certain now preferred forms of this invention have been illustrated and described, it is not limited thereto except insofar as such limitations are included in the following claims.

Having thus described the invention, what is claimed as new and desired to be secured by this Patent is as follows:

1. A dietary system for capturing and assessing calories and nutrients inputs so to provide dietary recommendations comprising:
a digital mat having a first microprocessor, a first memory, a load cell, a first wireless interface and a first power supply;
a digital device having a second microprocessor, a second memory, a second wireless interface and a second power supply;
said second wireless interface coupled to said first wireless interface;
wherein load cell data from said load cell is received by said first microprocessor and transmitted via said first wireless interface to said second wireless interface;
wherein said load cell data is received by said second wireless interface and coupled to a food item by said microprocessor;
wherein calorie and nutrient information is determined for said food item and load data and stored in said second memory.

2. The dietary system of claim 1 wherein said digital mat includes a touch display for entering said food item to associate with said load cell data.

3. A dietary system for capturing and assessing calories and nutrients inputs so to provide dietary recommendations comprising:
means for inputting a plurality of food item data for a food item concerning calorie data and nutrient data;
a digital scale outputting initial weight data for said food item and leftover weight data for a portion of said food item;
means for processing said food item data, initial weight data and leftover weight data;
a wireless communication module that communicates said food item data, initial weight data and leftover weight data with a smart device;
means for connecting with calories and nutrients databases to facilitate dietary analysis and provide actionable recommendations; and
means for displaying said results of said dietary analysis and said actionable recommendations.

4. The system of claim 3, wherein said means of inputting includes a touch screen.

5. The system of claim 3, wherein said means of inputting includes push buttons.

6. The system of claim 3, wherein said means of inputting includes voice recognition.

7. The system of claim 3, wherein said means of inputting includes picture recognition.

8. The system of claim 3, wherein said plurality of food item data includes a name of said food item.

9. The system of claim 3 wherein said plurality of food item data includes how said food item is prepared.

10. The system of claim 3 wherein said dietary analysis includes determining a net amount of said food item consumed.

11. The system of claim 3, wherein a speaker system is coupled to said means for processing to output a sound signal.

12. A method of food data inputs, performing dietary analyses, and providing actionable dietary recommendations, comprising:
capturing food data using a digital device;
storing said food data;
syncing said food data with a dietary database;
analyzing said food data;
performing a dietary gap analysis of said food data and dietary data;
providing calories and nutrients recommendations based on said analysis of said food data and dietary gap analysis;
providing actionable recommendations to said digital device.

13. The system of claim 12 wherein said storage is a Cloud storage.

14. The system of claim 12 wherein said storage is a local storage.
